(19) United States
(12) Patent Application Publication
(10) Pub. No.: US 2009/0276359 A1
(43) Pub. Date: Nov. 5, 2009

(54) Multi-Product-Multi-Channel Payment Platform System and Method

(75) Inventors: Behram Panthaki, Garden City, NY (US); Krishna Bhagavatula, Fremont, CA (US); Richard Bowman, Edison, NY (US); Vishal Bhatia, Santa Clara, CA (US); Diya Parial, Fremont, CA (US); Nash Ali, Santa Clara, CA (US); Amir Sunderji, San Jose, CA (US); Jeremy Sokolic, New York, NY (US); Yonghui Zhang, Fremont, CA (US)

Correspondence Address: COURTNEY STANIFORD & GREGORY LLP, P.O. BOX 9686, SAN JOSE, CA, 95157, US

(73) Assignee: CASHEDGE, INC., New York, NY (US)

(21) Appl. No.: 12/435,393

(22) Filed: May 4, 2009

Related U.S. Application Data
(63) Continuation-in-part of application No. 12/109,309, filed on Apr. 24, 2008.
Application No. 12/109,309 is a continuation-in-part of application No. 12/109,318, filed on Apr. 24, 2008.
(60) Provisional application No. 61/050,166, filed on May 2, 2008.

(51) Int. Cl. G06Q 40/00

(52) U.S. Cl. 705/44; 705/39

(57) ABSTRACT

Described herein is a multi-product-multi-channel payment platform system and apparatus that extends the capability of current online banking/funds-transfer systems. Different types of financial accounts are modeled in a financial management system to enable types of online, electronic funds transfer transaction that were not previously possible. Among novel elements of the system and apparatus disclosed is the enablement of real-time application of rules to different types of financial accounts and/or products across channels, such as how much money may be deposited or withdrawn in a period of time.

### RELATED APPLICATIONS

This application claims the benefit of U.S. Provisional Patent Application No. 61/050,166, filed May 2, 2008. This application is also a continuation-in-part of U.S. patent application Ser. No. 12/109,309, filed Apr. 24, 2008. This application is further a continuation-in-part of U.S. patent application Ser. No. 12/114,565, filed May 2, 2008. This application is also a continuation-in-part of U.S. patent application Ser. No. 12/109,318, filed Apr. 24,2008. Each of the foregoing referenced priority applications are hereby incorporated by reference in their entirety.

### TECHNICAL FIELD

The disclosed invention is in the field of electronic payment methods and systems, including electronic financial networks.

### BACKGROUND

There is existing capability to transfer funds online between financial accounts for various purposes. This includes transferring money between accounts belonging to a single entity, and transferring money between accounts belonging to different entities, for example for the purpose of paying amounts owed by one entity to another.

Previously disclosed methods and apparatus in the area of online funds transfer, particularly for payments, include U.S. patent application Ser. No. 12/109,309, filed Apr. 24, 2008, U.S. patent application Ser. No. 12/114,565, filed May 2, 2008, and U.S. patent application Ser. No. 12/109,318, filed Apr. 24, 2008, each currently commonly assigned to the assignee of the present application. All of the foregoing patent applications are incorporated by reference herein in their entirety. Among the inventions claimed in the previous applications are methods for transferring funds across financial networks.

In addition to the challenges to be overcome in order to transfer funds across financial networks, another challenge is transferring funds among different financial products. Consider that a loan product has different characteristics than a savings account product, and thus the characteristics of the transfer or transaction are also different. For example, one can only transfer money into a loan product, not out of a loan product. One might be able to make only one or two payments in a given month in the case of a loan product, etc. Further, different types of saving account products may have different characteristics, such as a regular savings account versus a certificate of deposit (CD). It would be desirable for consumers and financial institutions to have an online facility to execute multi-product-multi-channel transactions seamlessly with a single user interface.

### BRIEF DESCRIPTION OF THE DRAWINGS

FIG. 1 is a block diagram of a system according to embodiments.

FIG. 2 is a block diagram presenting an overview of the processes enabled by the invention according to an embodiment.

FIG. 3 is a user workflow according to an embodiment.

FIG. 4 is an illustration of some of the product types contemplated according to disclosed embodiments.

FIG. 5 is an illustration of an example suspension rules matrix according to an embodiment.

FIG. 6 is a flow diagram illustrating an analysis of “limits” according to an embodiment.

FIG. 7 is a diagram illustrating limit categories, limit types, and limit dimensions, according to an embodiment.

FIG. 8 is a block diagram illustrating a method of funds transfer between accounts according to an embodiment.

### DETAILED DESCRIPTION

Described herein is a multi-product-multi-channel payment platform system and apparatus that extends the capability of current online banking/funds-transfer systems. Different types of financial accounts are modeled in a financial management system to enable types of online, electronic funds transfer transaction that were not previously possible. Among novel elements of the system and apparatus disclosed is the enablement of real-time application of rules to different types of financial accounts and/or products across channels, such as how much money may be deposited or withdrawn in a period of time.

Another aspect of the invention as disclosed and claimed is the accommodation of a suspense account paradigm. According to known banking principles, many online transactions occur via automated clearing house (ACH) procedure. Some involved accounts might not be “ACHable”. ACH is just an example; a broader way of characterizing this limitation is that there is no publicly available payment engine to withdraw funds from the source account or deposit fund to the destination account. Thus, funds cannot be deposited directly into such accounts. According to embodiments, this difficulty is overcome because funds are withdrawn from different accounts, consolidated it into a single “credit”, and transferred to a financial institution, which in turn distributes the money to the account holders.

Aspects of the invention as disclosed and claimed are implementable via a web site, a kiosk, a mobile device, a customer service representative (CSR), and more.

Capabilities of the invention as disclosed and claimed include owner-to-owner capability, where an owner (or user) is any client entity initiating a transaction in the system.

Products encompassed within the disclosed and claimed invention include savings account products, demand deposit account (DDA) products, pre-paid credit card products, credit card products, line of credit (LOC) products, and various hybrid products as known in the financial services industry or to those skilled in the associated arts.

Channels or networks encompassed within the disclosed and claimed invention include automated clearing house (ACH) networks, automated teller machine (ATM) networks, credit card networks, bank proprietary networks, wire networks, “SWIFT” networks, and more.

Transaction completion capabilities encompassed within the disclosed and claimed invention include next day transfers, 3-day transfers and instant transfers.

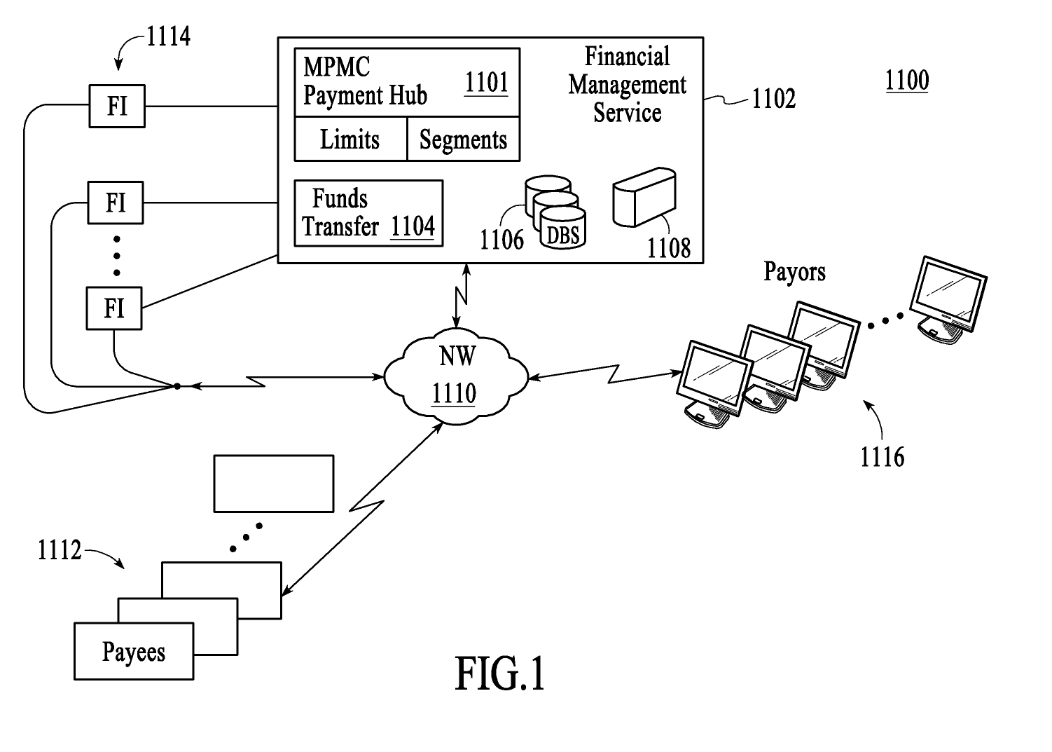

FIG. 1 is a block diagram of a system 1100 including a financial management system 1102, according to an embodiment. The financial management system hosts a multi-product-multi-channel (MPMC) payment hub 1101. The payment hub 1101 is an industrial utility in that multiple financial institutions 1114 all participate in a central service that can be offered to their respective customers of the financial institutions. The payment hub 1101 includes a module and a segments module as further described below.

All of the customers (both individuals and small businesses) of the various financial institutions access one consolidated payment hub 1101. For example a Bank of America invoice can come into the payment hub 1101, and a Wells Fargo invoice can come into the payment hub 1101. The payment hub 1101 is a shared utility across multiple financial institutions 1114. The payment hub 1101 features a single registration at the payment hub across all of the participating financial institutions 1114. In an embodiment, the payment hub appears to users (individuals and small businesses) as a single, neutrally branded payment center across all of the participating financial institutions 1114. Therefore, there is a single registration required in order for users to participate through any participating financial institution's web site or participating small business's web site.

In an embodiment, all of the participating financial institutions 1114 offer the same neutrally branded or co-branded services to their customers and the services are provided by the payment hub 1101. The value-added services this the payment hub allows the financial institutions 1114 to offer include originate point-to-point (P2P) payments, sending invoices and sending requests for payment of invoices, and merchant services/shopping cart payments on merchant web sites.

The payment hub 1101 features a common payment center/directory that enable customers to make payments on requests for payments/invoices, receive P2P payments, and make shopping cart payments on web sites for participating payees' websites.

Participating financial institutions (FISs) 1114 can thus provide services to end users through the payment hub 1101, yet control the customer relationship. Participating banks 1114 underwrite and authorize service limits, and collects revenues from subscriptions to the services.

Services to individual customers (or consumers) include sending person-to-person email payments, and sending requests for payment.

Services to small businesses include sending employee and vendor payments to know third parties (where financial information shared between sender and receiver), sending email payments to anyone (where financial information is not shared between sender and receiver), sending invoices to collect payments, and sending shopping cart invoices to collect point-of-sale (POS) payments.

The receiver role in transactions is supported by the financial management system 1102 through the payment hub 1101. The receiver services include receiving invoices or requests for payments, and making payments on both. The receiver services further include receiving (collecting) email payments, adding and verifying financial accounts (e.g., DDA, credit card), and assigning account preferences for receiving payments or making payments on invoices or requests for payments. In various embodiments, the roles of receiver and sender are less clearly separated. The roles could be combined in that many typical receiver or sender functions are performed by the opposite party. The receiver role could be extended to subsume the sender role in some instances, for example.

The system 1100 includes various entities in communication with each other via a network 1110, which is typically the Internet, but embodiments are not so limited. The financial management system 1102 includes databases 1106 that store financial institution information, user information, and customer information (including invoice information, payment information, payment history information, verification information, etc.). The CET service/payment hub 1101 is included in the financial management system 1102 and interoperates with a funds transfer module 1104. The funds transfer module 1104 communicates with multiple financial institutions to transfer funds as further described below. Servers 1108 host multiple web sites and applications as described herein, including biller-direct web sites, financial institution web sites, at least one payment hub service web site, invoicing applications, email applications, and setup applications, to name a few.

Payees 1112 communicate with the financial institutions 1114 to initiate their participation in the payment hub 1101. Individual customers also communicate with the financial institutions 1114 to initiate their participation in the payment hub 1101. Payor computers 1116 are an example of an interface between customers/payors and the financial institutions 1114 and between the customers/payors and the payment hub 1101 through the network 1110. Customers may interface with the network 1110 using other means, such as handheld devices, kiosks, etc.

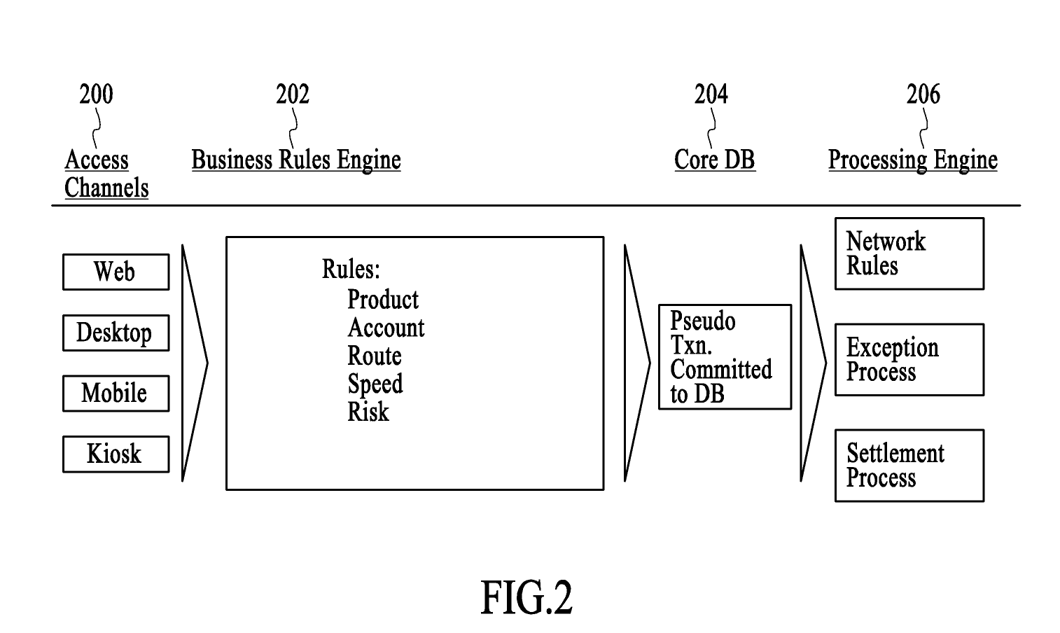

FIG. 2 is a block diagram presenting an overview of the processes enabled by the invention according to an embodiment. Any of access channels 200 can be used to access a business rules engine 202 that includes product rules, account rules, routing rules, speed (for example transmission speed and/or transaction speed) and risk rules. A core database (DB) 204 of MRMC payment hub 1101 receives data from the rules engine 202. According to processing of the core DB 204, a pseudo transaction is committed to a DB and processing engine of the payment hub 1101. A processing engine 204 applies network rules, exception processing and settlement processing before a transaction is actually committed.

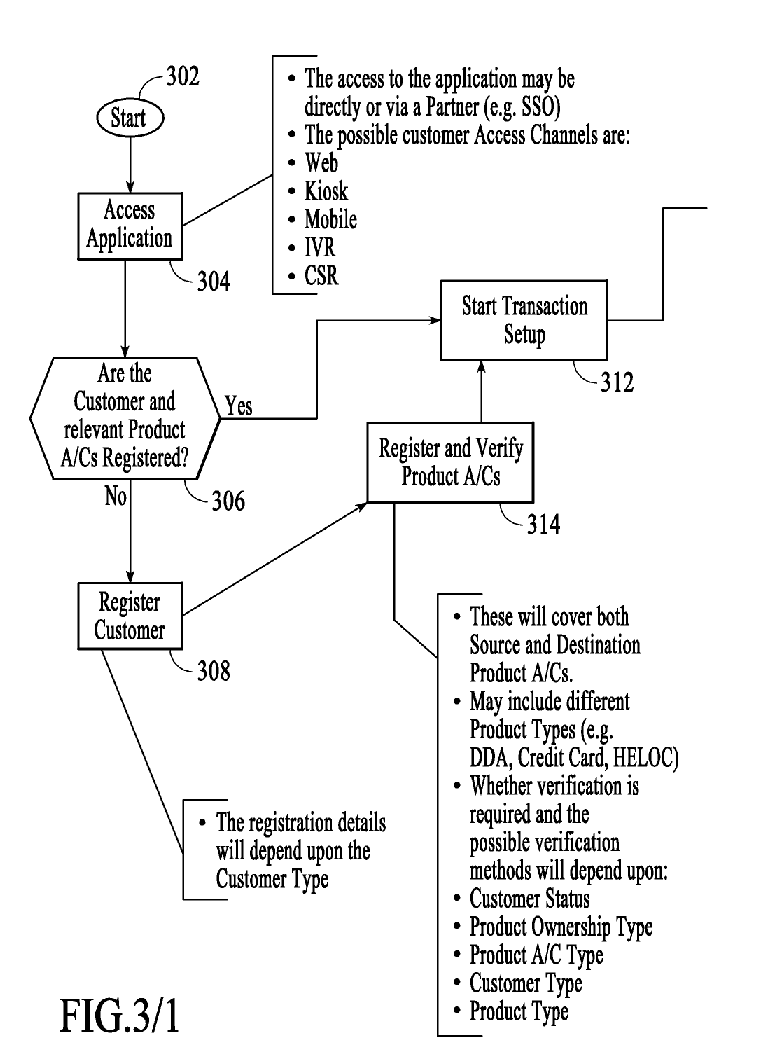

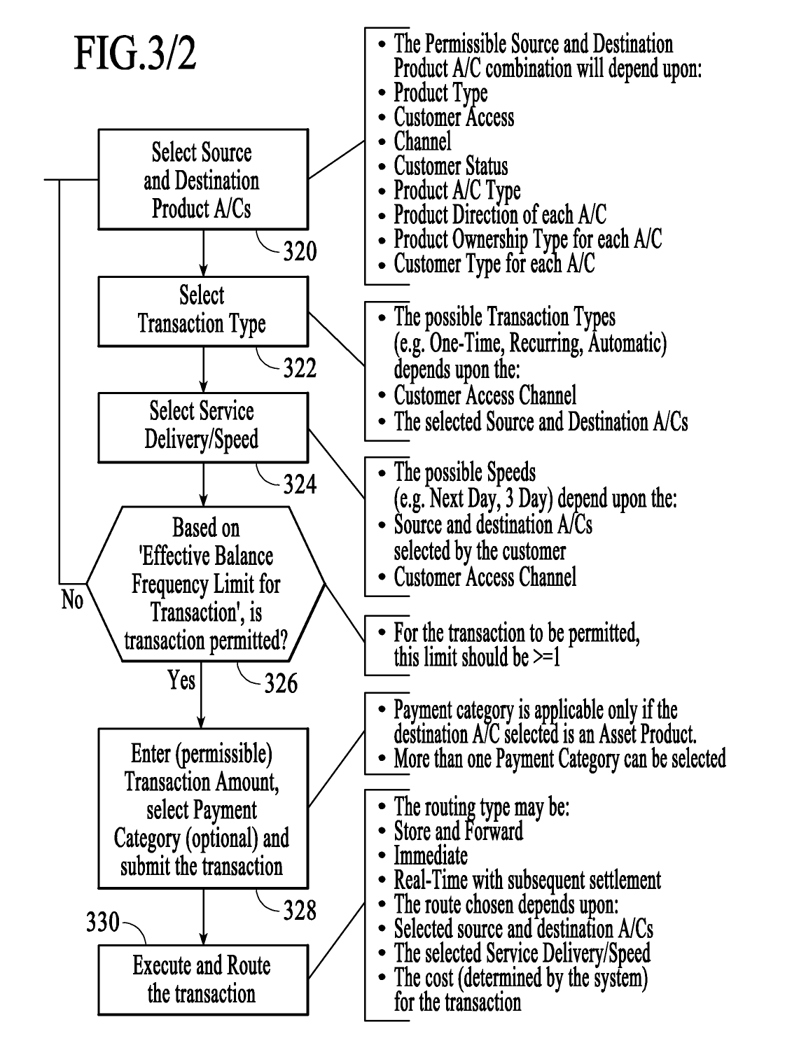

FIG. 3 is a user workflow according to an embodiment. The process starts at 302, and a MPMC application is accessed at 304. It is determined at 306 whether the customer and relevant product accounts (A/C) are registered. If not, the customer is registered at 308. If so, the transaction is begun at 312, and the (financial) product is registered and verified at 314.

Source and destination products are selected at 320. Transaction type is selected at 322. Service delivery and speed are chosen at 324. At 326 it is determined whether the transaction is permitted as requested. If it is permitted, details are entered at 328, and the transaction is executed and routed at 330.

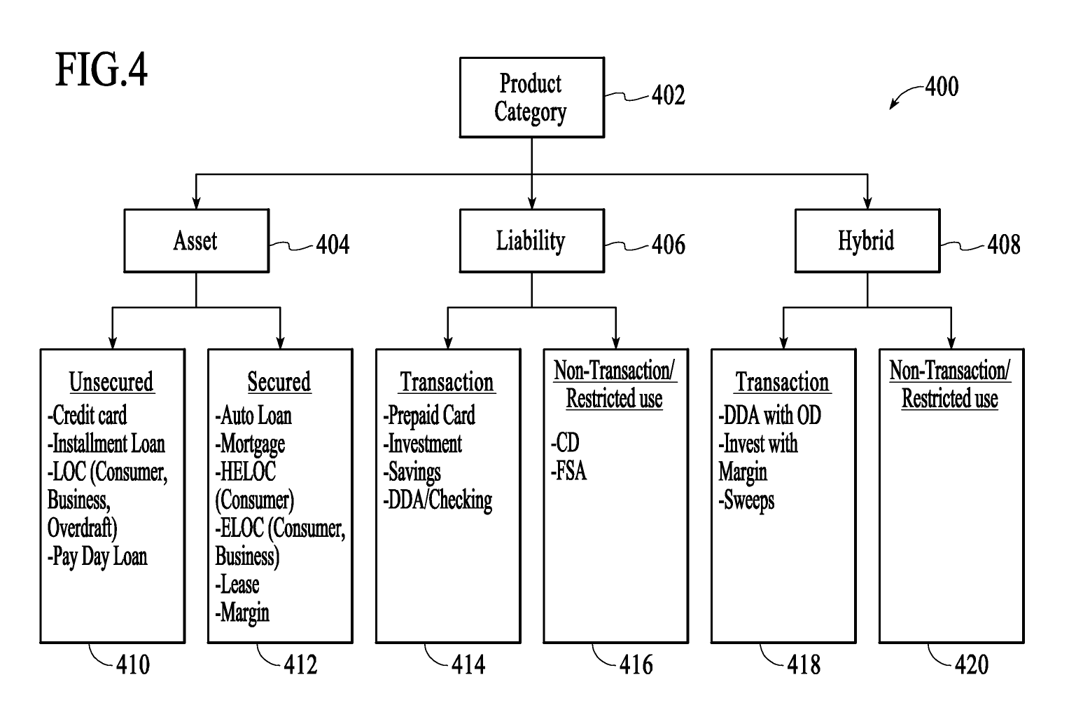

FIG. 4 is an illustration of some of the product types contemplated according to disclosed embodiments. Product categories 402 include assets 404, liabilities 406, and “hybrid” 408. Assets include the items shown at 410 and 412. Liabilities include the items shown at 414 and 416. Hybrids include the items shown at 418 and 420.

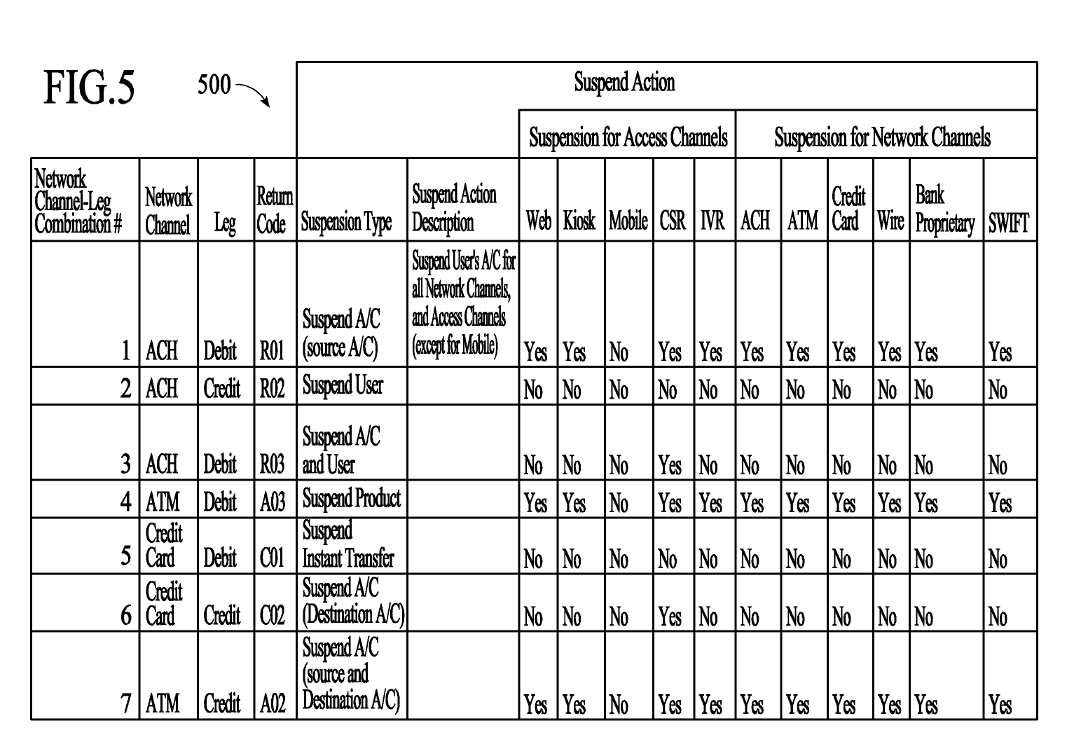

FIG. 5 is an illustration of an example suspension rules matrix according to an embodiment. As shown, suspension can occur according to different suspension types. In addition, there are various suspension actions, various suspensions for access channels and various suspensions for access channels.

In an embodiment, users or customers of the system are placed in segments. Each segment offers a set of permissible privileges, including “limits”. A limits matrix is defined at the segment level for each product type offered. All users in the same segment, as a default, have the same let of privileges including the same set of limits.

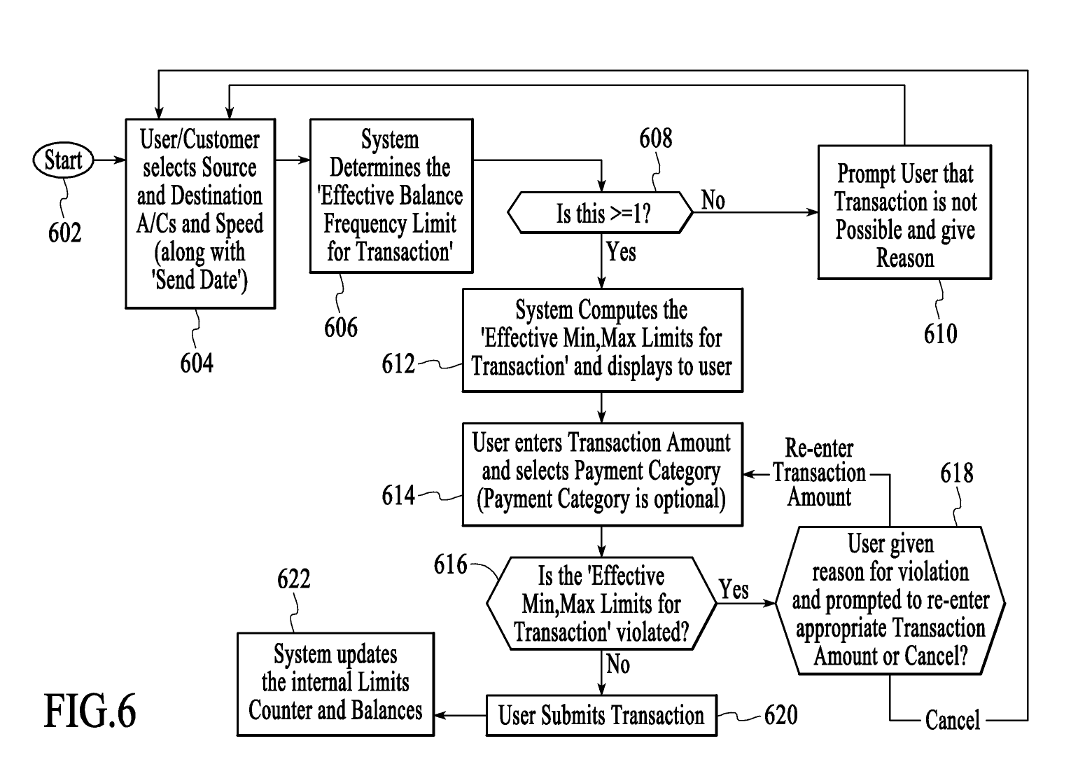

FIG. 6 is a flow diagram illustrating an analysis of limits according to an embodiment. After the start 602, a user selects source and destination accounts, as well as requested transaction speed and send date at 604. At 606, the system determines the effective balance frequency limitation for the requested transaction. It can also occur that the user is notified (prompted) after 604 that the transaction is not possible 610, including a reason. This can occur immediately after 603 or if the occurrence of the initial user request 603 is not the first such request, as shown at 608.

Effective limits for the transaction according to predetermined rules are computed at 612. The user enters the transaction amount and payment category (optional) at 614. If a predetermined (minimum or maximum) limit is violated at 616, the user must provide a reason for the violation and reenter the transaction amount, or cancel the transact ion at 618.

If the limit is not violated, the user may submit the transaction at 620, and the system then updates the internal limits counter and current account balances at 622.

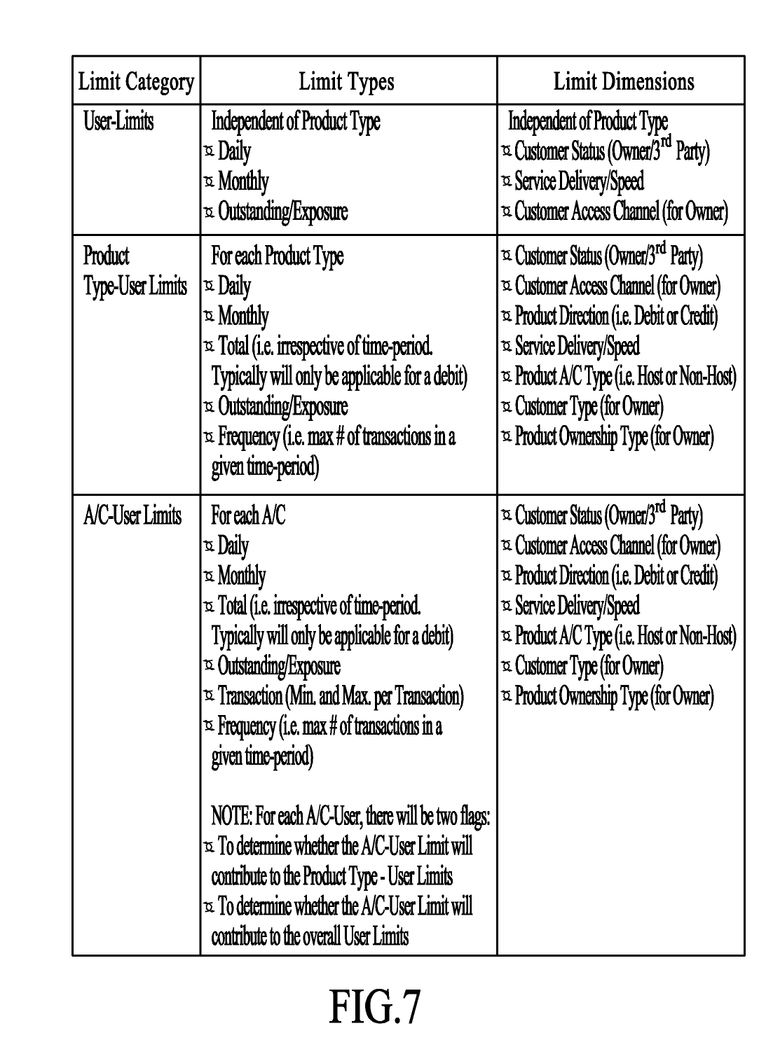

FIG. 7 is a diagram illustrating limit categories, limit types, and limit dimensions, according to an embodiment. The limits include user limits, product type-user limits, and account (A/C)-user limits as shown.

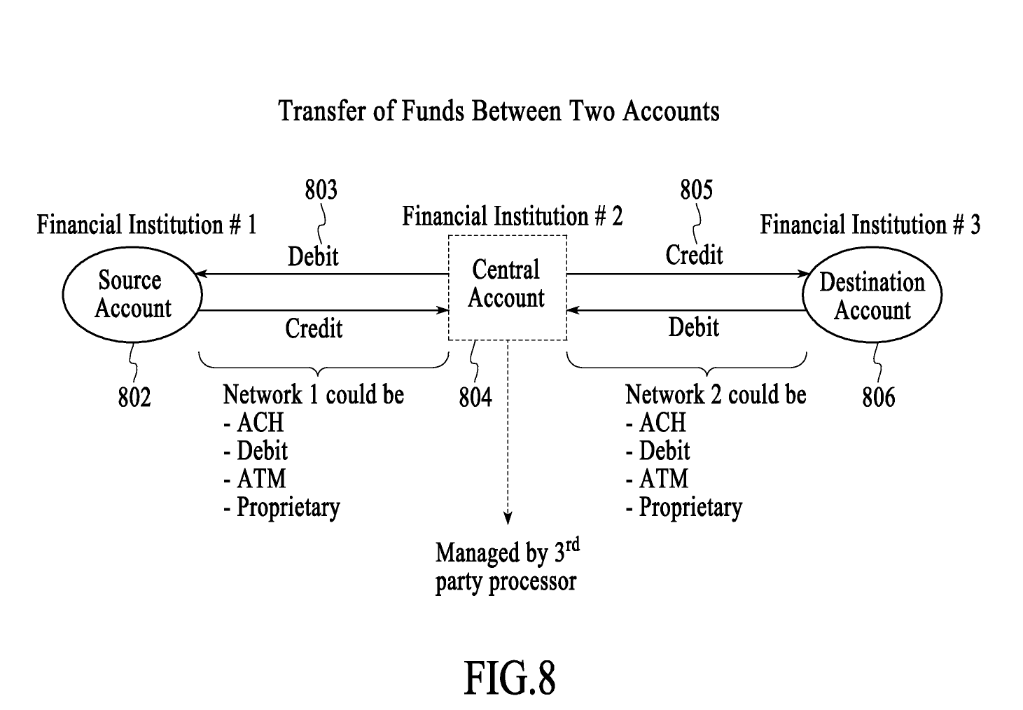

FIG. 8 is a block diagram illustrating an operation of funds transfer by funds transfer module 1104 of payment hub 1101, according to an embodiment. Financial institution #2 is for the benefit of the funds transfer module 1104, and in an embodiment is managed by a third party processor. In this instance “third party” infers that financial institution #2 is separate and independent from financial institution #1 and financial institution #3. In order to transfer funds from a source account 802 (for example a customer account) to a destination account 806 (such as a merchant account), the funds transfer module 1104 first executes a debit transaction with the source account 802. Then the funds from the first debit transaction are deposited in the central (or intermediate) account 804 in a first credit transaction.

The funds are then withdrawn from the central account 804 in a second debit transaction, and deposited in destination account 806 in a second credit transaction. Financial institutions #1 and #2 have no knowledge of central account 804. This is in contrast to conventional electronic funds transfers in which the financial institution providing the funds and the financial institution receiving the funds must deal directly with each other and have particular information or data about each other in order to complete the transaction. As shown, the debit and credit transactions can be accomplished using any one of various existing networks, including but not limited to an ACH network, a debit network, and an ATM network.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A multi-product-multi-channel payment platform system, comprising:
a financial management system hosting a multi-product-multi-channel payment hub, the financial management system configurable to receive input from a customer, the input comprising a requested transaction, a source account, and a destination account;
at least one module configurable to determine characteristics associated with the requested transaction;
a funds transfer module configurable to determine the execute at least one transfer of funds according to the requested transaction, wherein the transaction comprises a funds transfer among multiple financial products and among multiple financial channels.

2. The system of claim 1, wherein the financial products comprise:
asset products;
liability products; and
hybrid products.

3. The system of claim 2, wherein the asset products comprise unsecured credit products and secured credit products.

4. The system of claim 2, wherein the liability products comprise transaction products and non-transaction-restricted-use products.

5. The system of claim 2, wherein the hybrid products comprise transaction products and non-transaction-restricted-use products

6. The system of claim 1, wherein the system further comprises a business rules engine comprising rules related to products, accounts, routes, transaction speeds, and risks.

7. The system of claim 1, wherein the system further comprises a processing rules engine configurable to execute network rules, exception processing, and settlement processing.

8. A method for processing multi-product-multi-channel financial transactions, the method comprising:
receiving a user input including a request for a transaction, and one or more designated accounts;
determining whether the transaction is possible;
computing an effective limit for the transaction;
executing the transaction, wherein the transaction involves one or more of,
asset products;
liability products; and
hybrid products.

9. The method of claim 8, wherein executing the transaction comprises using one or more channels selected from a group comprising:
an automated clearing house (ACH) channel, an automated teller machine (ATM) channel, a credit card channel, a bank proprietary channel, a wire channel, and a “SWIFT” channel

10. The method of claim 8, further comprising determining limits associated with the transaction.

11. The method of claim 8, further comprising applying suspension rules to the transaction, wherein the suspension rules consider a network channel and an access channel.

12. The method of claim 8, further comprising determining whether the user and product are registered with a financial management system that executed the method.

13. The method of claim 12, further comprising selecting source and destination products for a fund transfer according to user input.

14. The method of claim 12, further comprising determining whether the transaction as requested is within permissible limits.

15. The method of claim 12, further comprising executing and routing the transaction.

16. A computer-readable medium having stored thereon instruction, that when executed in a financial management system cause a multi-product-multi-channel transaction method to be performed, the method comprising:
receiving a user input including a request for a transaction, and one or more designated accounts;
determining whether the transaction is possible;
computing an effective limit for the transaction;
executing the transaction, wherein the transaction involves one or more of,
asset products;
liability products; and
hybrid products.

17. The computer-readable medium of claim 16, wherein executing the transaction comprises using one or more channels selected from a group comprising:
an automated clearing house (ACH) channel, an automated teller machine (ATM) channel, a credit card channel, a bank proprietary channel, a wire channel, and a “SWIFT” channel

18. The computer-readable medium of claim 16, wherein the method further comprises determining limits associated with the transaction.

19. The computer-readable medium of claim 16, wherein the method further comprises applying suspension rules to the transaction, wherein the suspension rules consider a network channel and an access channel.

20. The met computer-readable medium of claim 16, wherein the method further comprises determining whether the user and product are registered with a financial management system that executed the method.

21. The computer-readable medium of claim 20, wherein the method further comprises selecting source and destination products for a fund transfer according to user input.

22. The computer-readable medium of claim 20, wherein the method further comprises determining whether the transaction as requested is within permissible limits.

23. The computer-readable medium of claim 20, wherein the method further comprises executing and routing the transaction.
